(19) United States
(12) Patent Application Publication
(10) Pub. No.: US 2023/0420722 A1
(43) Pub. Date: Dec. 28, 2023

(54) Battery Pack Assembly Apparatus and Method

(71) Applicants: Hyundai Motor Company, Seoul (KR); Kia Corporation, Seoul (KR)

(72) Inventor: Kyung Mo Kim, Hwaseong-si (KR)

(21) Appl. No.: 18/068,903

(22) Filed: Dec. 20, 2022

(30) Foreign Application Priority Data
Jun. 27, 2022 (KR) 10-2022-0077934

(51) Int. Cl. H01M 10/04

(52) U.S. Cl. CPC H01M 10/0404

(57) ABSTRACT

An embodiment battery pack assembly apparatus includes a cell gripper configured to grip a battery cell and to move the battery cell in a first direction and a cell guide including a slider movable in a second direction perpendicular to the first direction, wherein the cell guide is configured to guide movement of the battery cell in the first direction.

### CROSS-REFERENCE TO RELATED APPLICATIONS

This application claims the benefit of Korean Patent Application No. 10-2022-0077934, filed on Jun. 27, 2022, which application is hereby incorporated herein by reference.

### TECHNICAL FIELD

The present disclosure relates to an apparatus and method of assembling a battery pack.

### BACKGROUND

In general, in a secondary battery mounted on an electric vehicle or the like, a plurality of cells are integrated into a module, and a plurality of modules are integrated into a pack. Specifically, a battery module is manufactured by stacking about 4 to 6 prismatic cells and encapsulating the stacked cells with an enclosure having a cover and a metal housing. After the battery module is mounted on a tray of the battery pack, an upper cover is assembled to manufacture the battery pack. The componentized finished battery pack product is mounted on a vehicle body, for example, at a lower part thereof.

The volumetric energy density of battery cells has a great influence on the mileage of an electric vehicle. In other words, the mileage of an electric vehicle can be increased by arranging as many cells as possible in the same space. In the current battery pack manufacturing method, a respective cell, module, and pack are componentized. For a battery having a housing, the volume ratio of the cells (the volume occupied by cells in the space allocated for battery installation in an electric vehicle) is about half, and the other half is taken up by other mechanical strength-enhancing components, battery cooling related components, insulation components, or the like, which are irrelevant to the battery capacity.

If it becomes possible to manufacture more simplified batteries, it will ultimately be possible to increase the driving mileage per full charge of electric vehicles.

### SUMMARY

The present disclosure relates to an apparatus and method of assembling a battery pack. Particular embodiments relate to an apparatus and method of assembling cells into a pack without forming modules.

Embodiments of the present disclosure can solve problems associated with the related art, and an embodiment of the present disclosure provides a battery pack assembly apparatus and method capable of improving volumetric energy density of battery cells.

Another embodiment of the present disclosure provides a battery pack assembly apparatus and method that does not damage the alignment of cells seated in a pack even when assembling a large battery pack.

The embodiments of the present disclosure are not limited to the aforementioned embodiments, and other embodiments not mentioned may be clearly understood by those with ordinary skill in the art to which the present disclosure pertains (hereinafter “those skilled in the art”) from the following description.

The features of embodiments of the present disclosure for achieving embodiments of the present disclosure and performing characteristic functions of embodiments of the present disclosure to be described later are as follows below.

According to an embodiment of the present disclosure, there is provided a battery pack assembly apparatus including a cell gripper configured to grip a battery cell and to move the gripped cell in a first direction and a cell guide including a slider movable in a second direction perpendicular to the first direction, wherein the cell guide is configured to guide movement of the cell in the first direction.

According to another embodiment of the present disclosure, there is provided a battery pack assembly method including sequentially inserting a plurality of cells toward the center from opposite outer sides of a tray of a battery pack, stopping the insertion while leaving an extra space for inserting at least one cell between the plurality of cells, pushing two cells positioned at the center in opposite directions using a battery pack assembly apparatus, and inserting the at least one cell between the two cells pushed in opposite directions, using the assembly apparatus.

According to embodiments of the present disclosure, the battery pack assembly apparatus and method capable of improving the volume ratio of battery cells is provided.

According to embodiments of the present disclosure, the battery pack assembly apparatus and method that does not damage the alignment of cells seated in a pack even when assembling a large battery pack is provided.

The effects of embodiments of the present disclosure are not limited to those described above, and other effects not mentioned will be clearly recognized by those skilled in the art from the following description.

### BRIEF DESCRIPTION OF THE DRAWINGS

FIGS. 1A and 1B illustrate a cell-to-pack (CTP) battery manufacturing process;

FIG. 2A illustrates the press-fitting of a small pack in the cell-to-pack battery manufacturing process;

FIG. 2B illustrates alignment damage during the press-fitting of a large pack in the cell-to-pack battery manufacturing process;

FIGS. 3A and 3B illustrate a battery pack assembly method according to an embodiment of the present disclosure;

FIG. 4 illustrates a battery pack assembly apparatus according to an embodiment of the present disclosure;

FIG. 5 is a front view of a battery pack assembly apparatus according to an embodiment of the present disclosure;

FIG. 6 is a bottom perspective view of a battery pack assembly apparatus according to an embodiment of the present disclosure;

FIG. 7 is a simplified front view of a battery pack assembly apparatus according to an embodiment of the present disclosure; and

FIGS. 8A to 8H illustrate a cell insertion process through the battery pack assembly apparatus according to an embodiment of the present disclosure.

### DETAILED DESCRIPTION OF ILLUSTRATIVE EMBODIMENTS

Specific structural or functional descriptions presented in exemplary embodiments of the present disclosure are only exemplified for the purpose of describing the exemplary embodiments according to the concept of the present disclosure, and the exemplary embodiments according to the concept of the present disclosure may be carried out in various forms. Further, the exemplary embodiments should not be interpreted as being limited to the exemplary embodiments described in the present specification, and should be understood as including all modifications, equivalents, and substitutes included in the spirit and scope of the present disclosure.

Meanwhile, in embodiments of the present disclosure, terms such as first and/or second may be used to describe various components, but the components are not limited to the terms. The terms are used only for the purpose of distinguishing one component from other components. For example, a first component may be referred to as a second component, and similarly, the second component may also be referred to as the first component, without departing from the scope according to the concept of the present disclosure.

When a component is referred to as being “connected” or “coupled” to another component, it should be understood that the components may be directly connected or coupled to each other, but still other components may also exist therebetween. On the other hand, when a component is referred to as being “directly connected to” or “in direct contact with” another component, it should be understood that there is no other component therebetween. Other expressions for describing the relationship between components, that is, expressions such as “between” and “directly between” or “adjacent to” and “directly adjacent to” should also be interpreted in the same manner.

Throughout the specification, the same reference numerals refer to the same elements. Meanwhile, the terms used in the present specification are for the purpose of describing the exemplary embodiments and are not intended to limit the present disclosure. In the present specification, the singular form also includes the plural form unless otherwise specified in the phrase. “Comprises” and/or “comprising” used in the specification specifies the presence of the mentioned component, step, operation, and/or element, and does not exclude the presence or the addition of one or more other components, steps, operations, and/or elements.

Hereinafter, embodiments of the present disclosure will be described in detail with reference to the accompanying drawings.

In order to increase the volumetric energy density of cells as described above, a so-called cell-to-pack (CTP) battery in which cells are directly assembled into a pack without going through modularization has recently appeared.

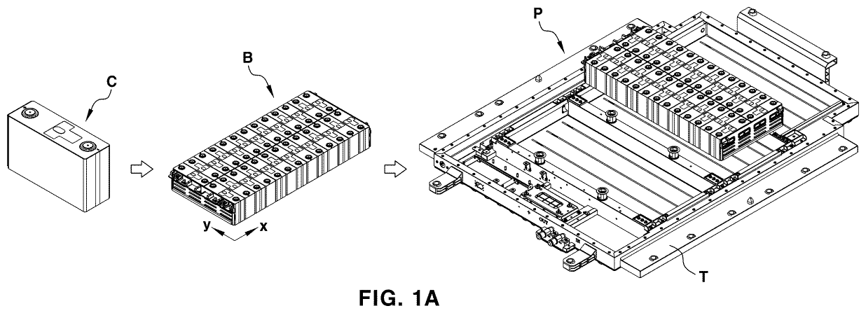

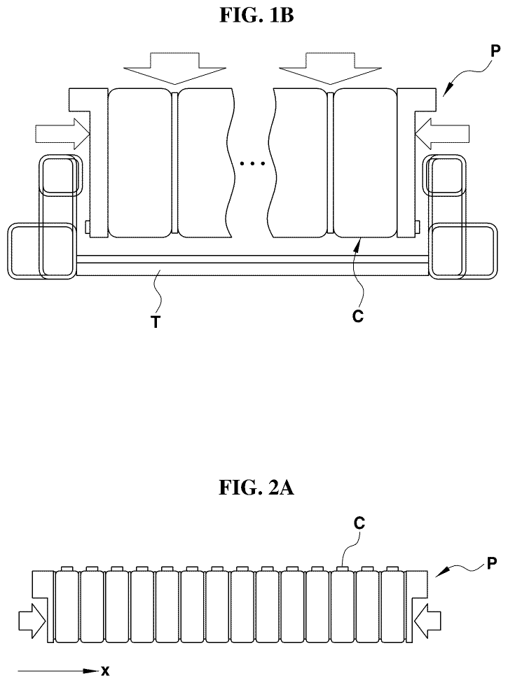

Referring to FIGS. 1A and 1B, in a CTP battery, prismatic cells C are assembled into a plurality of blocks B, which are in turn press-fitted into a tray T of a battery pack P. That is, instead of being seated on the tray T one by one, a certain number of prismatic cells C are collected in the form of a block B and then the blocks B are press-fitted with a certain pressure into the tray T of the battery pack P.

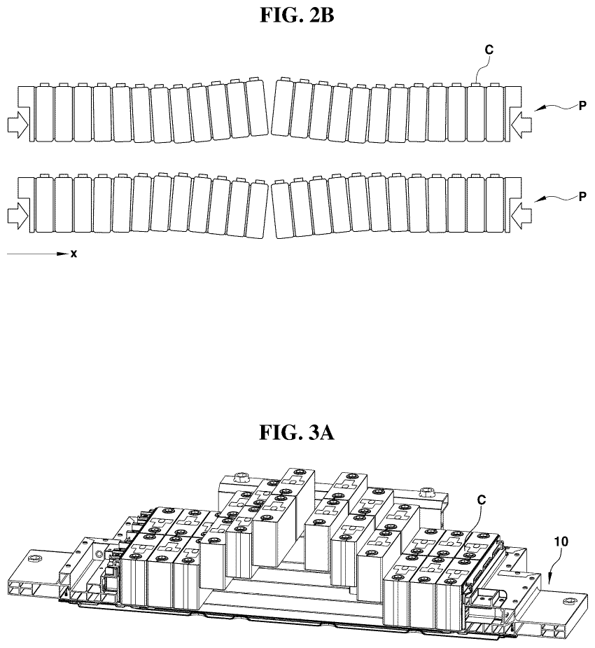

In this insertion method, the cells C can be prepared in advance in units of blocks, which is advantageous in terms of operation of the manufacturing line. In this case, when the cell block is manufactured by stacking the cells C in the lateral (y) direction in a small battery pack, there is no hardship in press-fitting. However, alignment problems may occur in case of stacking in the longitudinal (x) direction in the small pack or of stacking in a large battery pack. For example, when the number of stacked cells C in the cell block is small as illustrated in FIG. 2A, the alignment of the cells C may be maintained even when pressure is applied as illustrated by the arrow in FIG. 2A. However, when the number of stacked cells C is large as illustrated in FIG. 2B, alignment may be lost when pressing for press-fitting.

Accordingly, embodiments of the present disclosure provide a battery pack assembly apparatus and method capable of manufacturing a large battery pack and of preventing alignment loss during pressurization. According to embodiments of the present disclosure, it is possible to minimize the overlap of mechanical rigidity functions between the cell-module-pack and provide an integrated component having various functions such as cooling, housing, and mechanical rigidity functions. Therefore, it is possible to increase the number of cells loaded and simplify the assembly process while maintaining cooling, insulation, and mechanical configurations.

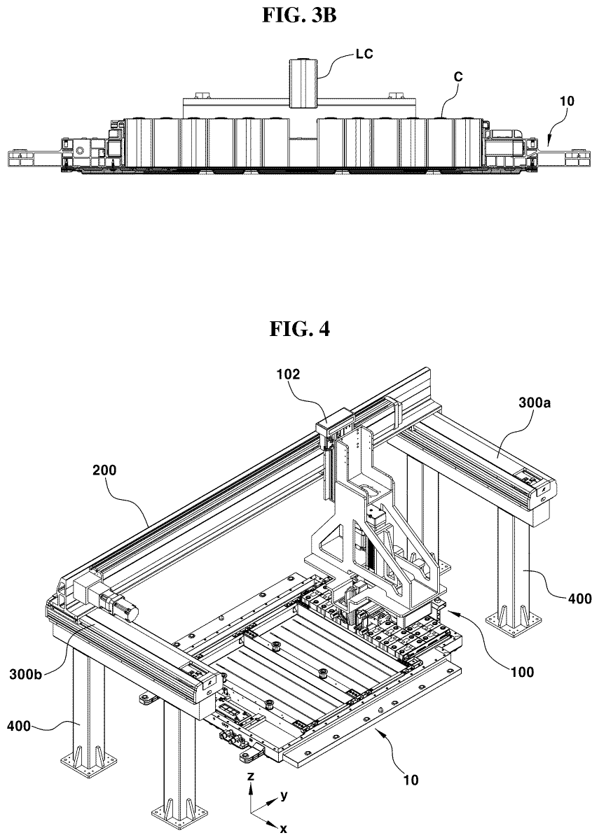

Specifically, according to embodiments of the present disclosure, seating prismatic cells C directly on a tray 20 of a battery pack 10 without a module structure is the same as the conventional CTP battery. However, in embodiments of the present disclosure, as illustrated in FIG. 3A, the cells C are seated one by one from the periphery of the tray 20 toward the center or from an outer wall of the tray to the center. However, before all the cells C are mounted, the insertion operation is stopped when an extra space in which at least one or two cells C can be inserted remains. As illustrated in FIG. 3B, after the cells stacked in the center are spaced apart from each other, the last cell LC is inserted into the center through the spaced gap. In this specification, the last cell LC refers to a cell inserted by a battery pack assembly apparatus 100, and may be the last cell to be mounted in the battery pack 10 or a cell to be mounted earlier than the last.

According to embodiments of the present disclosure, even in case of a large battery pack, it is possible to configure the process regardless of the number of cells C mounted in the longitudinal (x) direction.

Accordingly, embodiments of the present disclosure provide a battery pack assembly apparatus and method for placing the last cell LC in the battery pack 10.

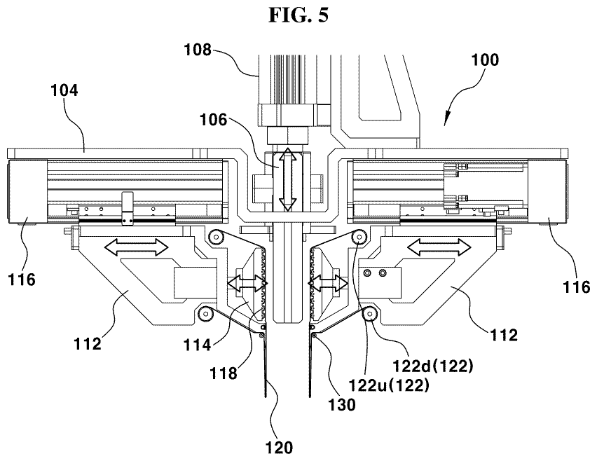

Referring to FIG. 4, the battery pack assembly apparatus 100 according to an embodiment of the present disclosure is mounted on a rail 200. The battery pack assembly apparatus 100 may include a hanger 102 to be movably coupled to the rail 200.

The rail 200 is supported by a pair of side members 300a, 300b. Each end of the rail 200 is coupled to each side member 300a, 300b. The rail 200 is configured to be movable along the side members 300a, 300b. The battery pack assembly apparatus 100 and the rail 200 may be movable with a force from a driving unit, such as a motor.

The pair of side members 300a, 300b may be supported by a plurality of legs 400. The rail 200 may be supported by the legs 400 through the pair of side members 300a, 300b. In the area defined by the legs 400, a battery pack 10 to which the cells C are to be assembled is placed.

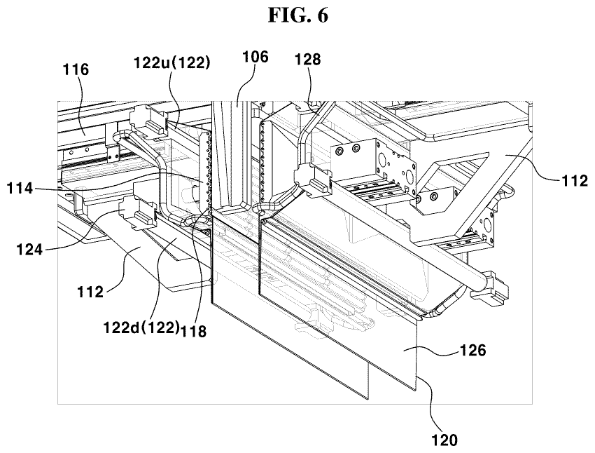

FIGS. 5 and 6 are partial front views of the battery pack assembly apparatus 100.

The battery pack assembly apparatus 100 includes a cell gripper and a cell guide. The cell gripper and the cell guide may operate around a base 104.

The cell gripper performs a function of bringing a cell C or a last cell LC from the outside of the battery pack 10 and gripping and moving the cell until the cell is mounted on the battery pack 10. According to an implementation of embodiments of the present disclosure, the cell gripper includes a grip portion 106 and an actuator 108.

The grip portion 106 may grip the cell C to be mounted on the battery pack 10. The grip portion 106 may move linearly with the driving of the actuator 108. In some implementations, the actuator 108 may be an electric cylinder. The grip portion 106 may be connected to a piston rod 110 of the electric cylinder so that the grip portion 106 may move in a z-axis direction by the operation of the electric cylinder.

The cell guide is configured to secure a space for inserting the last cell LC into the tray 20. In addition, the cell guide may prevent damage to the adjacent cell C when the last cell LC is mounted on the tray 20. In addition, the cell guide may guide the movement of the cell C gripped by the cell gripper. According to an implementation of embodiments of the present disclosure, the cell guide includes a slider 112 and a face support 114.

The slider 112 is configured to be movable in an x-axis direction. To this end, according to an implementation of embodiments of the present disclosure, the slider 112 is configured to be movable along the x-axis direction by a slider transporter 116 mounted on the base 104. As a non-limiting example, the slider transporter may be a linear actuator. The sliders 112 may be respectively provided one by one on opposite sides of the cell C to be gripped.

The face support 114 is connected to the slider 112. The face support 114 includes a plurality of rolling elements 118. In addition, the slider 112 is provided with a guide film 120. Two or more film rollers 122 capable of winding and unwinding the guide film 120 are provided. The film roller 122 may include an upper film roller 122u disposed on the upper side of the face support 114 and a lower film roller 122d disposed on the lower side of the face support 114. One end of the guide film 120 is wound around the upper film roller 122u, and the other end of the guide film 120 is wound around the lower film roller 122d. Each film roller 122 is configured to be rotatable by a film motor 124.

The guide film 120 is configured to be periodically replaced after being put into the battery pack assembly apparatus 100 for a preset number of times. Since the guide film 120 is used a plurality of times, for example, 50 times or more, the guide film is formed of a material with sufficient durability. In addition, the guide film 120 may also be formed of a material having a low coefficient of friction and having properties, such as abrasion resistance, corrosion resistance, chemical resistance, heat resistance, non-oiliness, dimensional stability, and electrical insulation. As a non-limiting example, the material of the guide film 120 may be a PTFE coated glass fabric sheet coated with a PTFE heat-resistant coating.

The guide film 120 is supported by the face support 114 between the upper film roller 122u and the lower film roller 122d. In particular, the movement of the guide film 120 may be supported by the rolling element 118 of the face support 114.

The guide film 120 is configured to extend downward in the z-axis direction farther than the lower film roller 122d. To this end, according to an implementation of embodiments of the present disclosure, an air knife 126 is provided between the folded portions of the guide film 120 to maintain the set shape of the guide film 120 even under the lower film roller 122d. To this end, according to an implementation of embodiments of the present disclosure, the battery pack assembly apparatus 100 includes an air line 128. The air line 128 may be configured to spray air at a high pressure of a predetermined value or more between the folded portions of the guide film to form the air knife 126.

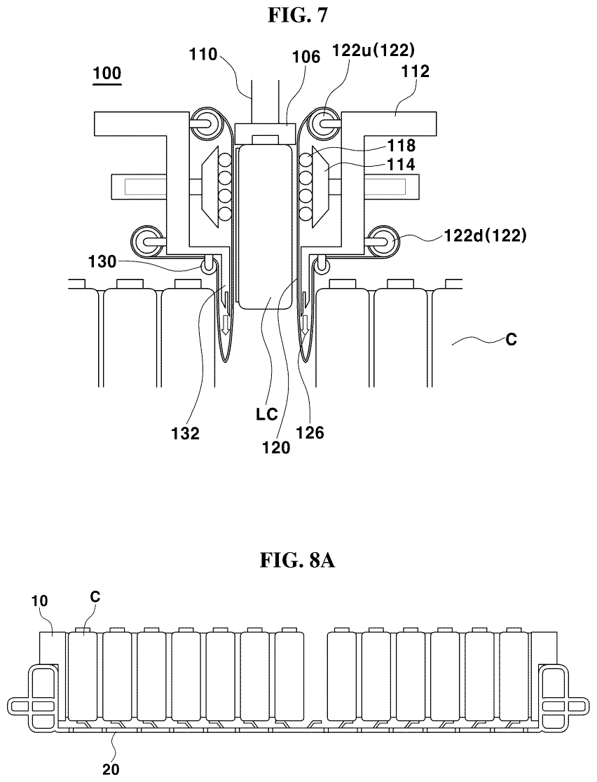

With further reference to FIG. 7, the slider 112 also includes a pushing arm 132. The pushing arm 132 pushes the cell C in the battery pack 10 to secure a space. The pushing arm 132 may be provided in the air knife 126. It is not necessary for the pushing arm 132 to extend the entire length of the air knife 126, but only a part of the length is sufficient.

The above-described cell guides may be provided symmetrically on both sides of the cell gripper. Since the above description can be equally applied to the cell guide on the opposite side, a redundant description thereof will be omitted.

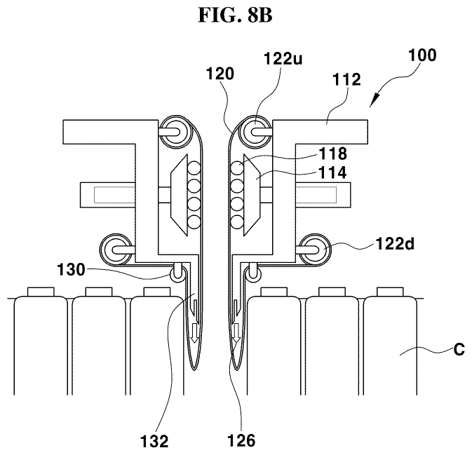

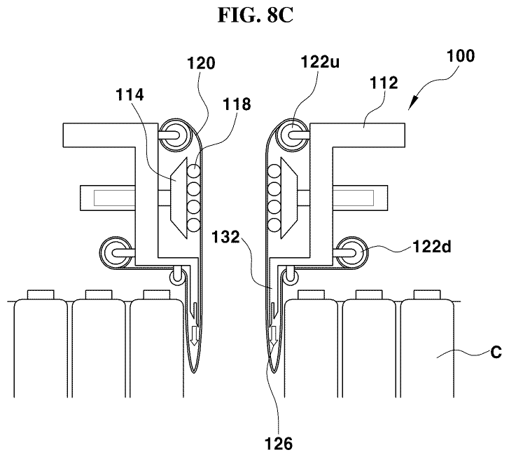

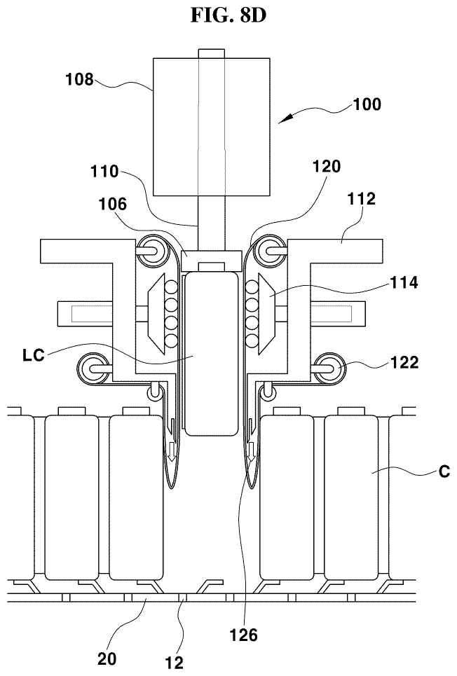

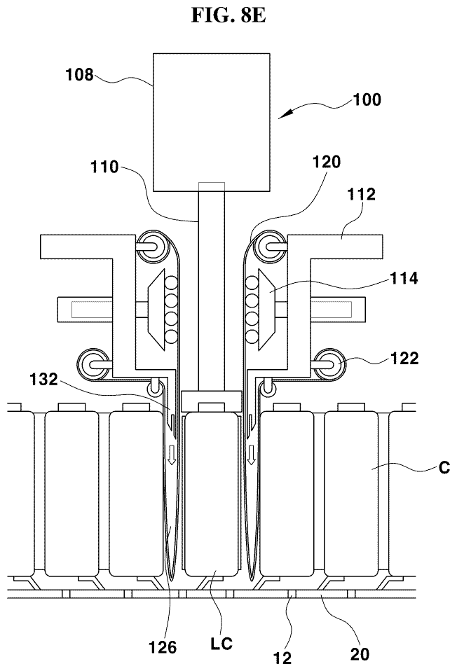

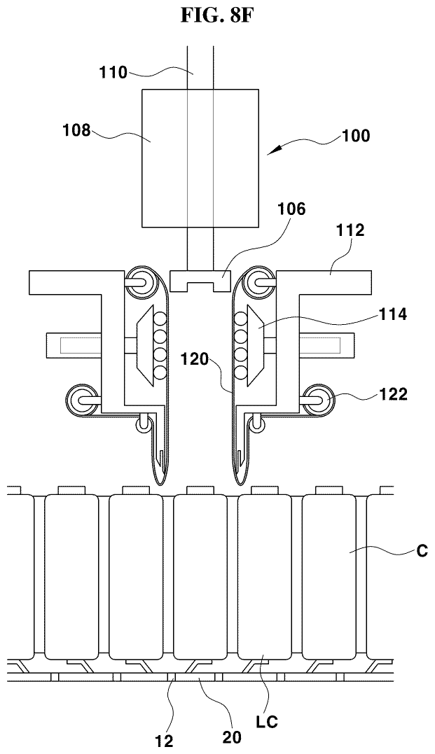

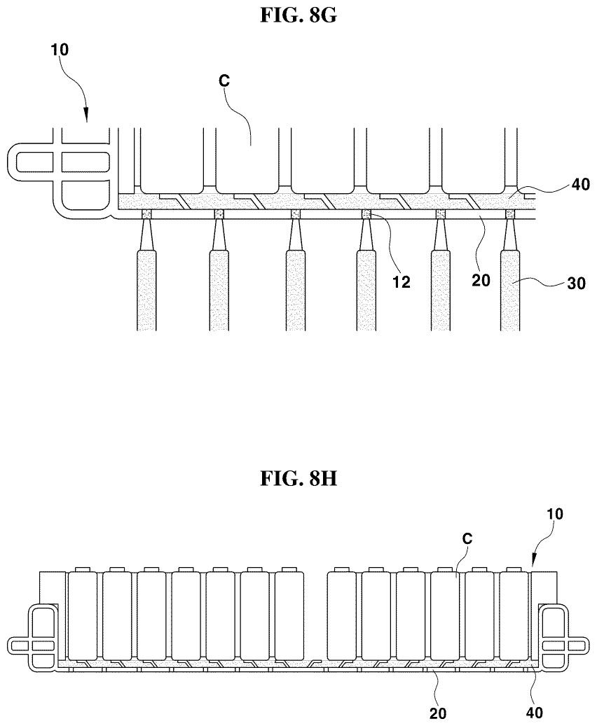

Hereinafter, the operation of the battery pack assembly apparatus according to embodiments of the present disclosure will be described with reference to FIGS. 8A to 8H.

The battery pack 10 is placed in the working space as illustrated in FIG. 4 above. As illustrated in FIG. 8A, the cells C are seated on the tray 20 of the battery pack 10 from both ends toward the center. The inserting of the cells C is stopped when an extra space, for example, a space sufficient to accommodate one or two cells C, remains.

In FIG. 8B, the battery pack assembly apparatus 100 moves to a position where the last cell LC is to be inserted in a state of being gripped by the cell gripper. The movement of the battery pack assembly apparatus 100 may be accomplished by movement on the rail 200 and/or movement of the rail 200. The cell guide of the battery pack assembly apparatus 100 starts securing a space in which the last cell LC is inserted in the battery pack 10. Specifically, when the pushing arm 132 pushes the two cells C directly adjacent to each other at the center to opposite sides, a space is formed (see FIG. 8C).

Next, as illustrated in FIG. 8D, the last cell LC mounted on the grip portion 106 of the cell gripper starts descending by the operation of the actuator 108. At this time, in particular, the air knife 126 is formed by air supplied by the air line 128. The guide film 120 under the lower film roller 122d may be maintained in shape by the air knife 126. The portion of the guide film 120 maintained in shape by the air knife 126 may prevent damage to the cells C directly adjacent to the last cell LC. The last cell LC that begins descending is supported by the face support 114 with the guide film 120 interposed therebetween. When descending, the guide film 120 may be unwound from the upper film roller 122u. As the last cell LC descends, the guide film 120 is also unwound. At this time, the movement of the guide film 120 is supported by the rolling element 118 of the face support 114.

As illustrated in FIG. 8E, the last cell LC continues to descend and is seated on the tray 20. As illustrated in FIG. 8F, the battery pack assembly apparatus 100 including the cell gripper and the pushing arm 132 that was pushing the adjacent cell C is raised, and the seating is completed while the guide film 120 is wound by the film roller 122.

Conventionally, a cooling channel is provided at the bottom of the battery pack tray, and a gap filler is first applied to fill a void between the bottoms of the cells. However, in this case, when the cells inserted into the tray are spread left and right by the battery pack assembly apparatus of embodiments of the present disclosure, it may be difficult to secure an insertion space due to the adhesive force of the gap filler or slippage of the gap filler may occur.

Referring to FIG. 8G, in case such a problem occurs, according to embodiments of the present disclosure, a certain gap is provided between the upper surface of the cooling channel under the tray 20 of the battery pack 10 and the lower portion of the cell C. In this case, after all the cells C are inserted first, the gap filler 40 may be injected from the lower portion of the tray 20 of the battery pack 10.

Specifically, according to embodiments of the present disclosure, the tray 20 of the battery pack 10 may include a plurality of injection holes 12. The gap filler 40 supplied by a filler injector 30 fills the gap through the injection holes 12, thereby solving the above-described problems. FIG. 8H illustrates a cross-section of the battery pack 10 in which the injection of the gap filler 40 is completed.

Embodiments of the present disclosure enable the manufacture of CTP batteries while maintaining the alignment of cells without limiting the number of cells mounted in the longitudinal direction.

The aforementioned embodiments of present disclosure is not limited by the aforementioned exemplary embodiments and the accompanying drawings, and it will be apparent to those skilled in the art that various substitutions, modifications, and changes may be made without departing the technical sprit of the present disclosure.

What is claimed is:

1. A battery pack assembly apparatus, the apparatus comprising:
a cell gripper configured to grip a battery cell and to move the battery cell in a first direction; and
a cell guide comprising a slider movable in a second direction perpendicular to the first direction, wherein the cell guide is configured to guide movement of the battery cell in the first direction.

2. The apparatus of claim 1, wherein the cell gripper comprises a grip portion configured to grip the battery cell and an actuator configured to move the grip portion in the first direction.

3. The apparatus of claim 1, wherein the slider comprises a first slider and a second slider, wherein the first slider and the second slider are configured to be movable in a direction away from or approaching each other along the second direction.

4. The apparatus of claim 3, wherein the cell guide further comprises a slider transporter configured to provide a moving force to the first slider and the second slider.

5. The apparatus of claim 3, wherein each of the first slider and the second slider comprises:
a face support; and
a guide film configured to be movable along the face support.

6. The apparatus of claim 5, wherein the face support comprises a plurality of rolling elements configured to be in contact with the guide film.

7. The apparatus of claim 5, wherein each of the first slider and the second slider comprises a pushing arm below the face support.

8. The apparatus of claim 7, wherein the guide film extends from the cell guide to position the pushing arm inside the guide film.

9. The apparatus of claim 8, wherein the cell guide further comprises an air knife configured to inject air from an air line configured to provide high-pressure air toward the guide film from the pushing arm side.

10. The apparatus of claim 9, further comprising a guide roller configured to position the guide film on the cell guide to maintain the shape of the air knife.

11. The apparatus of claim 5, wherein:
a first end of the guide film is configured to be wound and unwound by an upper film roller disposed above the face support in the first direction; and
a second end of the guide film is configured to be wound and unwound by a lower film roller disposed below the face support in the first direction.

12. The apparatus of claim 11, wherein the upper film roller and the lower film roller are configured to be wound or unwound by operations of film motors for the upper film roller and the lower film roller, respectively.

13. The apparatus of claim 1, wherein the battery cell comprises a prismatic cell.

14. A battery pack assembly method, the method comprising:
sequentially inserting a plurality of cells toward a center from opposite outer sides of a tray of a battery pack;
stopping the inserting while leaving an extra space for inserting a last cell between the plurality of cells;
pushing two cells positioned at the center in opposite directions using a battery pack assembly apparatus; and
inserting the last cell between the two cells pushed in opposite directions using the battery pack assembly apparatus.

15. The method of claim 14, further comprising stopping the battery pack assembly method after inserting the last cell.

16. The method of claim 14, further comprising, after inserting the last cell, injecting a gap filler through a plurality of injection holes provided in the tray.

17. The method of claim 14, wherein the battery pack assembly apparatus comprises a cell guide, and wherein the cell guide comprises:
a pair of pushing arms configured to respectively push the two cells in opposite directions; and
a slider transporter configured to provide a moving force to the pair of pushing arms.

18. The method of claim 17, wherein the battery pack assembly apparatus comprises:
a gripper configured to grip the last cell; and
an actuator configured to move the gripper between the pair of pushing arms.

19. The method of claim 17, wherein the cell guide further comprises a guide film that is movable along the cell guide in a state of being in contact with the last cell.

20. The method of claim 19, wherein, when the last cell is inserted into the tray, the method further comprises injecting high-pressure air from inside the guide film so that the guide film extends into the tray.
